(19) United States
(12) Patent Application Publication
(10) Pub. No.: US 2010/0257276 A1
(43) Pub. Date: Oct. 7, 2010

(54) VIRTUAL NETWORK INTERFACE FOR RELAYED NAT TRAVERSAL

(75) Inventor: Teemu Ilmari Savolainen, Nokia (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/744,360

(22) PCT Filed: Nov. 22, 2007
(86) PCT No.: PCT/FI07/50634

§ 371 Date: May 24, 2010

(51) Int. Cl. G06F 15/16

(52) U.S. Cl. 709/230

(57) ABSTRACT

By providing a virtual network interface (1140) to a platform or an operating system wide implementation of the STUN protocol and its TURN extension, the invention allows applications (1110, 1120, 1130) located in a private network behind a NAT to communicate with their respective peers (1321, 1322, 1323) using sockets as usual while still getting the full benefit of the STUN protocol and its TURN extension for NAT traversal purposes.

### BACKGROUND OF THE INVENTION

1. Field of the Invention

The present invention relates to telecommunications. In particular, the present invention relates to Network Address Translator traversal using a relay.

2. Description of the Related Art

Network Address Translation (NAT) is a computer networking technique of transmitting and receiving network traffic through a router that involves rewriting the source and/or destination IP (Internet protocol) addresses and typically also the TCP/UDP (Transmission Control Protocol/User Datagram Protocol) port numbers of data packets as they pass through. Typically Network Address Translation is used to enable multiple hosts on a private network to access the Internet using a single public IP address.

Network Address Translation has its drawbacks, however. For example, it breaks many existing IP applications and makes it difficult to deploy new ones. Examples of such affected protocols include many peer-to-peer protocols, such as multimedia communications protocols (e.g. Voice over IP or VoIP) and file sharing protocols.

STUN (Session Traversal Utilities for Network Address Translation; previously also known as Simple Traversal Underneath Network Address Translators, as well as Simple Traversal of User Datagram Protocol Through Network Address Translators) is a network protocol developed to address some of the issues related to Network Address Translation. STUN allows a client behind a Network Address Translator(s) to find out its public address (or its reflexive transport address), the type of Network Address Translator it is behind, and the internet-side port associated by the Network Address Translator with a particular local port. Typically, this information is then used to set up e.g. UDP communication between two hosts of which one or both are behind Network Address Translator routers.

However, this reflexive transport address can be used by the client for receiving packets from peers only when the client is behind “good” NATs. In particular, if a client is behind a NAT whose mapping behavior is address or address and port dependent, the reflexive transport address will not be usable for communicating with a peer.

To address this problem, an extension to STUN protocol called TURN (Traversal Using Relays around NAT) has been developed. A TURN server acts as a relay that sits on the public side of a NAT, and allocates transport addresses to clients reaching it from behind the private side of the NAT. These allocated addresses are from interfaces on the relay (i.e. TURN server). When the relay receives a packet on one of these allocated addresses, the relay forwards it toward the client.

While STUN in combination with its extension TURN does provide a working solution to NAT traversal, presently a client portion of the STUN protocol with its TURN extension is typically implemented directly in each application (such as e.g. VoIP client application) requiring its services.

Yet, today there are often multiple applications provided in a single device (such as e.g. a communications terminal device) each of which requires services of the STUN protocol and its TURN extension. It would be useful to implement the STUN protocol and its TURN extension to a platform or an operating system as a service that can simultaneously be used by multiple applications.

At the same time, if the STUN protocol and its TURN extension were implemented as a service provided by a platform, it would be beneficial if applications needed minimal changes to utilize the STUN protocol and its TURN extension. Since various applications involved in packet switched data communications typically utilize sockets, it would be beneficial if these applications could communicate with their respective peers using sockets as usual while still getting the full benefit of the STUN protocol and its TURN extension for NAT traversal purposes.

### SUMMARY OF THE INVENTION

A first aspect of the present invention is a method in which, in response to at least one socket being bound to a relayed transport address by at least one application, socket calls made by the at least one application to the bound socket are intercepted, each intercepted socket call is replaced with a predetermined network address translator traversal protocol message, and the network address translator traversal protocol messages are forwarded to a network address translator traversal server. The relayed transport address has been assigned by the network address translator traversal server for data packet relay use by the at least one application behind the network address translator. In response to at least one network address translator traversal protocol message being sent from the network address translator traversal server to the at least one application, the sent at least one network address translator traversal protocol message is intercepted, data in the intercepted at least one network address translator traversal protocol message is analyzed, and the data is forwarded to the at least one socket bound to the relayed transport address based on the analysis.

A second aspect of the present invention is an apparatus which comprises a first interceptor that is configured to intercept, in response to at least one socket being bound to a relayed transport address by at least one application behind a network address translator, socket calls made by the at least one application to the bound socket, replace each intercepted socket call with a predetermined network address translator traversal protocol message, and forward the network address translator traversal protocol messages to a network address translator traversal server, the relayed transport address having been assigned by the network address translator traversal server for data packet relay use by the at least one application behind the network address translator. The apparatus of the second aspect further comprises a second interceptor that is configured to, in response to at least one network address translator traversal protocol message being sent from the network address translator traversal server to the at least one application, intercept the sent at least one network address translator traversal protocol message, analyze data in the intercepted at least one network address translator traversal protocol message, and forward the data to the at least one socket bound to the relayed transport address based on the analysis.

A third aspect of the present invention is a computer program embodied on a computer readable medium, the computer program controlling a data-processing device to perform:

in response to at least one socket being bound to a relayed transport address by at least one application, intercepting socket calls made by the at least one application to the bound socket, replacing each intercepted socket call with a predetermined network address translator traversal protocol message, and forwarding the network address translator traversal protocol messages to a network address translator traversal server, the relayed transport address having been assigned by the network address translator traversal server for data packet relay use by the at least one application behind the network address translator; and

in response to at least one network address translator traversal protocol message being sent from the network address translator traversal server to the at least one application, intercepting the sent at least one network address translator traversal protocol message, analyzing data in the intercepted at least one network address translator traversal protocol message, and forwarding the data to the at least one socket bound to the relayed transport address based on the analysis.

A fourth aspect of the present invention is an apparatus which comprises a first intercepting means for, in response to at least one socket being bound to a relayed transport address by at least one application behind a network address translator, intercepting socket calls made by the at least one application to the bound socket, replacing each intercepted socket call with a predetermined network address translator traversal protocol message, and forwarding the network address translator traversal protocol messages to a network address translator traversal server, the relayed transport address having been assigned by the network address translator traversal server for data packet relay use by the at least one application behind the network address translator. The apparatus of the fourth aspect further comprises a second intercepting means for, in response to at least one network address translator traversal protocol message being sent from the network address translator traversal server to the at least one application, intercepting the sent at least one network address translator traversal protocol message, analyzing data in the intercepted at least one network address translator traversal protocol message, and forwarding the data to the at least one socket bound to the relayed transport address based on the analysis.

In an embodiment of the invention, the network address translator traversal protocol comprises a Session Traversal Utilities for Network Address Translation (STUN)-protocol provided with Traversal Using Relays around Network Address Translation (TURN)-extension.

In an embodiment of the invention, at least one intercepted socket call comprises a socket call connect( ), and wherein the replacing predetermined network address translator traversal protocol message comprises a Connect Request-message.

In an embodiment of the invention, at least one intercepted socket call comprises a socket call connect( ), and wherein the replacing predetermined network address translator traversal protocol message comprises a Set Active Destination Request-message.

In an embodiment of the invention, at least one intercepted socket call comprises a socket call send( ), and wherein the replacing predetermined network address translator traversal protocol message comprises a Send Indication-message.

In an embodiment of the invention, at least one intercepted socket call comprises a socket call recv( ), and wherein the replacing predetermined network address translator traversal protocol message comprises a Data Indication-message.

In an embodiment of the invention, the at least one socket bound to the relayed transport address comprises one of a datagram socket and a stream socket.

In an embodiment of the invention, the assigned relayed transport address comprises multiple ports, each for binding to one socket.

It is to be understood that the aspects and embodiments of the invention described above may be used in any combination with each other. Several of the aspects and embodiments may be combined together to form a further embodiment of the invention. A method, an apparatus, a system or a computer program which is an aspect of the invention may comprise at least one of the embodiments of the invention described above.

The invention allows applications located in a private network behind a NAT to communicate with their respective peers using sockets as usual while still getting the full benefit of the STUN protocol and its TURN extension for NAT traversal purposes. The invention allows these applications to utilize the STUN protocol and its TURN extension with minimal or no changes to the applications themselves since no client portion of the STUN protocol or its TURN extension need to be implemented in the applications. Rather, the invention provides a virtual network interface to a platform or operating system wide implementation of the STUN protocol and its TURN extension that enables the applications to communicate with their respective peers using sockets as usual.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a block diagram illustrating an apparatus according to an embodiment of the present invention, and

FIGS. 2a-2b are a signaling diagram illustrating a method according to an embodiment of the invention.

### DETAILED DESCRIPTION OF THE PREFERRED EMBODIMENTS

Reference will now be made in detail to the embodiments of the present invention, examples of which are illustrated in the accompanying drawings.

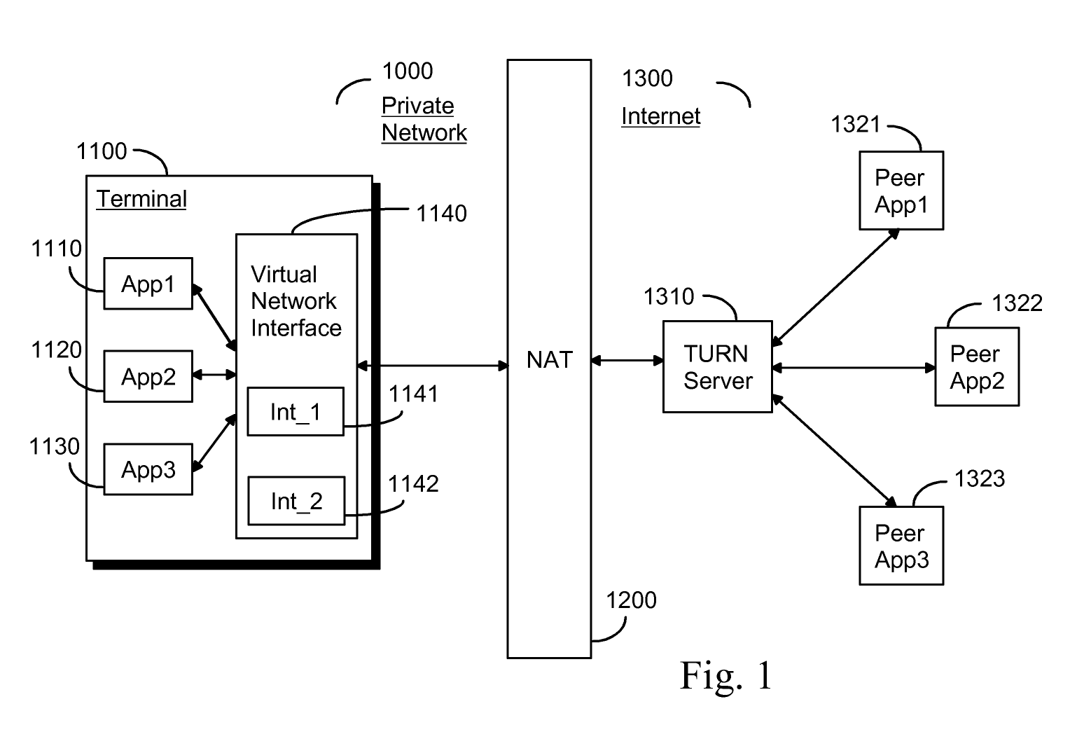

FIG. 1 is a block diagram illustrating an apparatus according to an embodiment of the invention. Terminal device 1100 is arranged in a private network 1000 (e.g. a Local Area network or a LAN). The private network 1000 is connected to public Internet 1300 via a Network Address Translator 1200. The private network 1000 is “private” in the sense that its designated address (e.g. Internet Protocol or IP address) space is in use only inside the private network 1000. The Network Address Translator 1200 has a private address in the private address space of the private network 1000, and the Network Address Translator 1200 further has at least one public address in the public address space of the Internet 1300. As traffic passes from the private network 1000 to the Internet 1300, the source address in each packet is translated on the fly from the private addresses to the public address. The Network Address Translator 1200 tracks such data about each active connection as the destination address and port. When a reply returns from the Internet 1300 to the Network Address Translator 1200, it uses the connection tracking data it stored during the outbound phase to determine where on the private network 1000 to forward the reply. To an application or a system on the Internet 1300, the Network Address Translator 1200 itself appears to be the source/destination for this traffic.

A TURN server 1310 is arranged in the Internet 1300. Implementing appropriate portions of STUN (Session Traversal Utilities for Network Address Translation) protocol together with its extension TURN (Traversal Using Relays around NAT), the TURN server 1310 acts as a relay that sits on the public side of the NAT 1200, and allocates transport addresses to applications 1110, 1120, 1130 reaching it from behind the private side of the NAT 1200. These allocated addresses (also known as relayed transport addresses) are from interfaces on the relay or TURN server 1310. When the TURN server 1310 receives a packet from the Internet (e.g. from one of peer applications 1321, 1322, 1323) on one of these allocated addresses, the TURN server 1310 forwards it towards the appropriate application 1110, 1120, or 1130. Thus, NAT traversal is enabled in the arrangement illustrated in FIG. 1. It is to be understood that the TURN server 1310 does not need to a separate server. Rather, the functionality of the TURN server 1310 may be implemented in a suitable network element in the Internet 1300 that may have other functions also.

The applications 1110, 1120, 1130 and peer applications 1321, 1322, 1323 may be e.g. Voice over Internet Protocol (VoIP) applications or other peer-to-peer applications. The terminal 1100 may be e.g. a smart phone, a personal digital assistant (PDA), or a laptop computer. It is to be understood that there may be multiple terminals in the private network 1000 even though only one is illustrated in FIG. 1 for the sake of clarity, and each of these multiple terminals may comprise multiple applications communicating with peer applications in the Internet 1300.

In an embodiment of the invention, at least one of the applications 1110, 1120, 1130 is configured to trigger and/or perform the determination or obtaining of a relayed transport address assigned by the network address translator traversal server (i.e. the TURN server 1310 in the embodiment of the invention illustrated in FIG. 1) for data packet relay use by at least one of the applications 1110, 1120, 1130 behind the Network Address Translator 1200 (i.e. in the private network 1000). In another embodiment of the invention, the relayed transport address determination or obtaining may be triggered and/or performed e.g. by an operating system (not illustrated in FIG. 1) of the terminal 1100. In yet another embodiment of the invention, the relayed transport address determination or obtaining may be triggered and/or performed e.g. by a virtual network interface 1140 of the invention.

For example, in an embodiment, the application 1110, 1120 or 1130 might request setup of the relayed transport address from the operating system of the terminal 1100 that would then get the relayed transport address from the TURN server. Furthermore, in accordance with the invention, the operating system of the terminal 1100 would then instantiate the virtual network interface 1140 of the invention.

In another embodiment, the relayed transport address determination or obtaining may be triggered and/or performed by an appropriate middleware—e.g. by a component that implements ICE (Interactive Connectivity Establishment) protocol—in response to a relayed transport address being required for peer-to-peer connection, for example. In this case, the application 1110, 1120 or 1130 may e.g. request a peer-to-peer socket connection from the middleware ICE-component which may then get the relayed transport address from the TURN server and instantiate the virtual network interface 1140 of the invention.

In accordance with an embodiment of the invention, the virtual network interface 1140 is arranged in the terminal 1100. In an embodiment, the virtual network interface 1140 may be implemented as software, e.g. as a part of the operating system of the terminal 1100. For example, the virtual network interface 1140 may be implemented e.g. as a service provided by the operating system of the terminal 1100. In case of there being multiple terminals in the private network 1000, the virtual network interface 1140 may be implemented in each of these multiple terminals.

Further in accordance with the above embodiment of the invention, the virtual network interface 1140 further comprises a first interceptor 1141 that is configured to intercept, in response to at least one of the applications 1110, 1120, 1130 binding at least one socket to the relayed transport address, socket calls made by the at least one application 1110, 1120, 1130 to the bound socket. The first interceptor 1141 is further configured to replace each intercepted socket call with a predetermined network address translator traversal protocol message (e.g. a TURN message). The first interceptor 1141 is further configured to forward these network address translator traversal protocol messages to the TURN server 1310.

Further in accordance with the above embodiment of the invention, the virtual network interface 1140 further comprises a second interceptor 1142 that is configured to, in response to at least one network address translator traversal protocol message (e.g. a TURN message) being sent from the TURN server 1310 to at least one of the applications 1110, 1120, 1130, intercept the sent at least one network address translator traversal protocol message. The second interceptor 1142 is further configured to analyze data in the intercepted at least one network address translator traversal protocol message. The second interceptor 1142 is further configured to forward the data to the at least one socket bound to the relayed transport address based on the analysis.

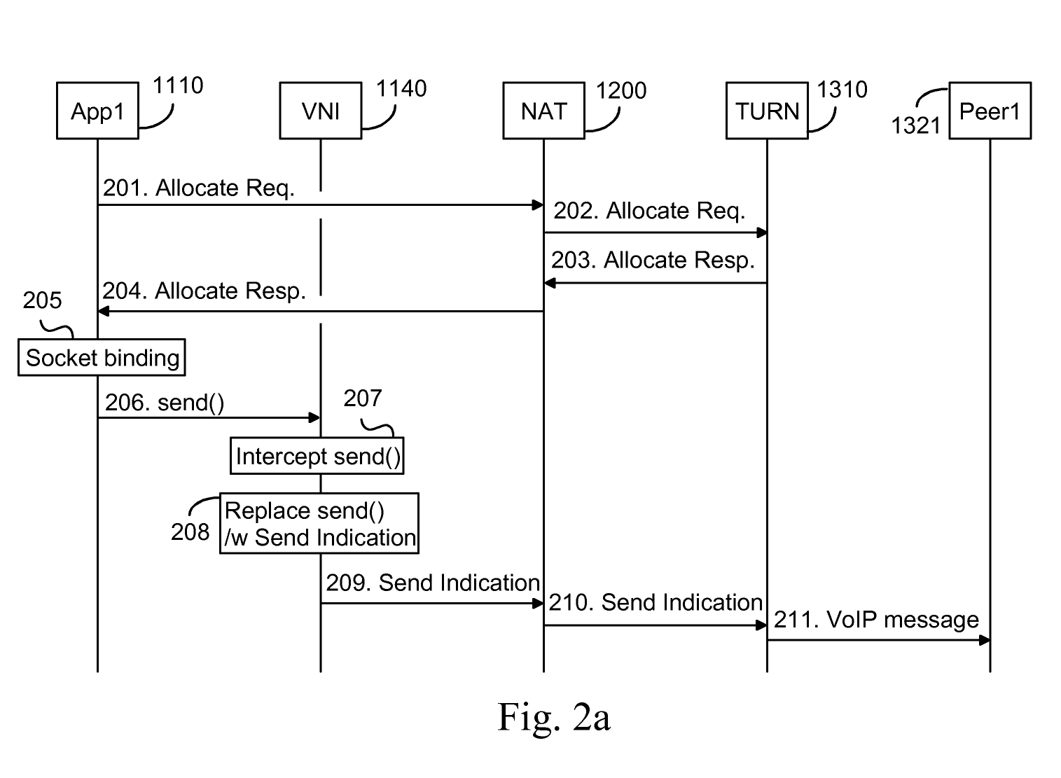

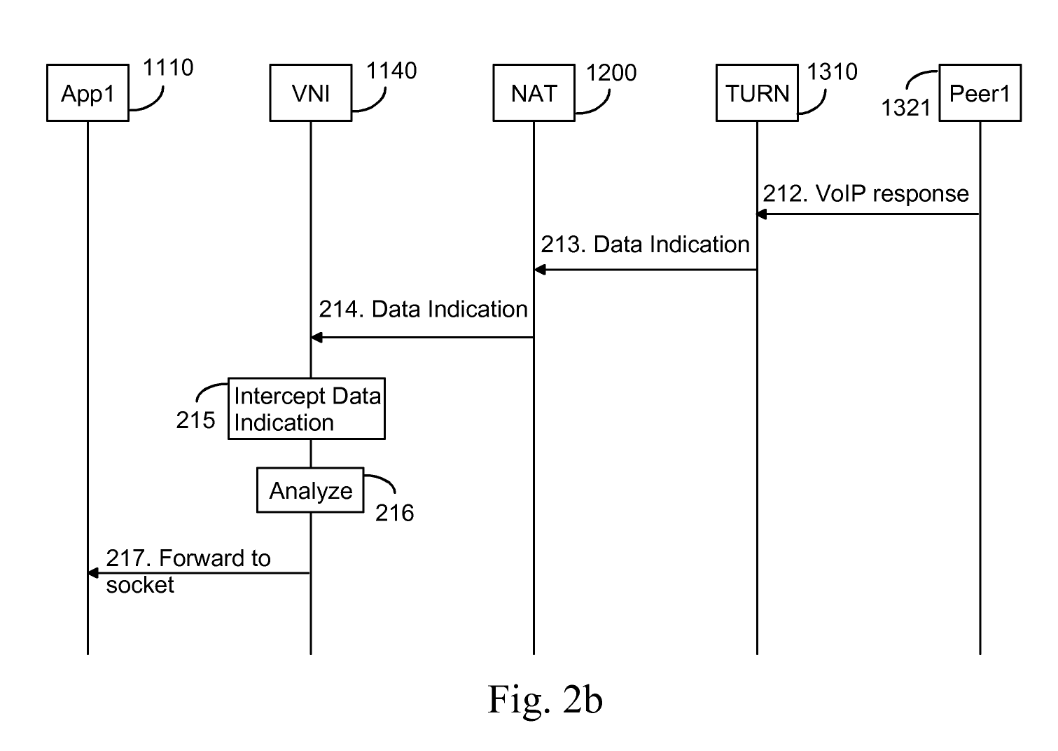

FIGS. 2a-2b show a flow diagram illustrating a method according to an embodiment of the invention.

FIG. 2a is a flow diagram illustrating a method according to an embodiment of the invention. The first application 1110, the virtual network interface 1140, the network address translator 1200, the TURN server 1310 and the first peer application 1321 of FIG. 1 are also illustrated in FIGS. 2a-2b. The first application 1110 and the first peer application 1321 may be e.g. Voice over Internet Protocol (VoIP) applications. In the embodiment of the invention illustrated in FIGS. 2a-2b, the Internet Protocol (IP) address of the terminal 1100 (depicted in FIG. 1), and consequently that of the first application 1110, is 10.0.1.1. As described above, this is a private address, i.e. it can only be used inside the private network 1000. Further in the embodiment of the invention illustrated in FIGS. 2a-2b, the public IP address of the network address translator 1200 is 192.0.2.1. The TURN server 1310 is listening for TURN requests on IP address 192.0.2.3 at port 8776. Further in the embodiment of the invention illustrated in FIGS. 2a-2b, the IP address of the first peer application 1321 is 192.0.2.17 and it uses port 12734 for VoIP.

At first, a relayed transport address is obtained from the TURN server 1310 at steps 201-204. The steps 201-204 are a simplified example of how to obtain the relayed transport address, since the details of this process are not relevant to the present invention.

At step, 201, a TURN protocol message ‘Allocate Request’ is sent from the first application 1110 towards the TURN server 1310. Thus, the source address of the ‘Allocate Request’ is 10.0.1.1:4334 (the first application 1110 having been allocating port 4334 on the interface of the terminal 1100 for its traffic in the present example), and the destination address of the ‘Allocate Request’ is 192.0.2.3:8776. The ‘Allocate Request’ arrives at the network address translator 1200 which replaces the source address to 192.0.2.1:63346 (and creates a mapping from 192.0.2.1:63346 to 10.0.1.1:4334 for later use). Then, the network address translator 1200 forwards the ‘Allocate Request’ to the TURN server 1310, step 202. In response to the received ‘Allocate Request’, the TURN server 1310 allocates 192.0.2.3:32766 as the relayed transport address. At step 203, the TURN server 1310 sends a TURN protocol message ‘Allocate Response’ containing the relayed transport address 192.0.2.3:32766. The source address of the ‘Allocate Response’ is 192.0.2.3:8776, and the destination address of the ‘Allocate Response’ is 192.0.2.1:63346, i.e. the ‘Allocate Response’ is sent to the network address translator 1200 which then forwards the ‘Allocate Response’ to the first application 1110 at address 10.0.1.1:4334 based on the mapping the network address translator 1200 created earlier. As a result, a relayed transport address 192.0.2.3:32766 has now been obtained for use by the first application 1110 (as well as by the applications 1120 and 1130).

At step 205, the first application 1110 binds a socket to the relayed transport address 192.0.2.3:32766 in order to begin establishing e.g. VoIP communications.

In accordance with the invention, from now on the relayed transport address 192.0.2.3:32766 allocated in steps 201-204 will actually be set up as an address for the virtual network interface of the invention. That is, socket calls from the applications 1110, 1120, 1130 to the relayed transport address 192.0.2.3:32766 will be intercepted and replaced with appropriate protocol messages, as detailed below.

At step 206, the first application 1110 makes a socket call send( ) to the bound socket containing data related to VoIP communications to be established with the first peer application 1321. For example, the contained data may be a VoIP request message addressed to the first peer application 1321 (a VoIP application, as described above) at the above address 192.0.2.17:12734.

At step 207, the socket call send( ) is intercepted by the virtual network interface 1140 of the invention. At step 208, the socket call send( ) is replaced with a TURN protocol message ‘Send Indication’. That is, a ‘Send Indication’ message is created containing the data (the VoIP request message in the present example) originally contained in the socket call send( ). At step 209, the ‘Send Indication’ is forwarded to the TURN server 1310 via the network address translator 1200 which again replaces the source address 10.0.1.1:4334 and creates a mapping from 192.0.2.1:63346 to 10.0.1.1:4334, as above, steps 209-210.

The TURN server 1310 extracts data—i.e. the VoIP request message in the present example—contained in the received ‘Send Indication’ message, and forwards the extracted VoIP request message to the first peer application 1321 at 192.0.2.17:12734, step 211.

The first peer application 1321 sends a VoIP response message to the source address 192.0.2.3:32766 of the received VoIP request message, i.e. to the relayed transport address at the TURN server 1310. The TURN server 1310 encapsulates the received VoIP response message in a TURN protocol message ‘Data Indication’ and sends it to destination address 192.0.2.1:63346 (i.e. the network address translator 1200) with the original source address 192.0.2.17:12734 contained in the ‘Data Indication’ message, step 213.

The network address translator 1200 forwards the ‘Data Indication’ message towards the first application 1110 at address 10.0.1.1:4334 based on the mapping the network address translator 1200 created earlier, step 214. At step 215, the ‘Data Indication’ message is intercepted by the virtual network interface 1140 of the invention. At step 216, the virtual network interface 1140 analyzes the intercepted ‘Data Indication’ message and determines that it contains a VoIP response message addressed from 192.0.2.17:12734 to 10.0.1.1:4334. Based on this analysis, the virtual network interface 1140 forwards the VoIP response message to the earlier bound socket. As a result, the VoIP response message reaches the first application 1110. From the point of view of the first application 1110, this request-response communication was executed with socket operations. In other words, no STUN/TURN client functionalities need to be implemented in applications 1110, 1120, 1130.

In addition to utilizing various TURN protocol messages, such as Set Active Destination, Data Indication, and Send Indication in delivering application data, as described above, TURN protocol channel allocations may also be utilized, as appropriate.

The exemplary embodiments can include, for example, any suitable servers, workstations, PCs, laptop computers, PDAs, Internet appliances, handheld devices, cellular telephones, wireless devices, other devices, and the like, capable of performing the processes of the exemplary embodiments. The devices and subsystems of the exemplary embodiments can communicate with each other using any suitable protocol and can be implemented using one or more programmed computer systems or devices.

One or more interface mechanisms can be used with the exemplary embodiments, including, for example, Internet access, telecommunications in any suitable form (e.g., voice, modem, and the like), wireless communications media, and the like. For example, employed communications networks or links can include one or more wireless communications networks, cellular communications networks, 3 G communications networks, Public Switched Telephone Network (PSTNs), Packet Data Networks (PDNs), the Internet, intranets, a combination thereof, and the like.

It is to be understood that the exemplary embodiments are for exemplary purposes, as many variations of the specific hardware used to implement the exemplary embodiments are possible, as will be appreciated by those skilled in the hardware and/or software art(s). For example, the functionality of one or more of the components of the exemplary embodiments can be implemented via one or more hardware and/or software devices.

The exemplary embodiments can store information relating to various processes described herein. This information can be stored in one or more memories, such as a hard disk, optical disk, magneto-optical disk, RAM, and the like. One or more databases can store the information used to implement the exemplary embodiments of the present inventions. The databases can be organized using data structures (e.g., records, tables, arrays, fields, graphs, trees, lists, and the like) included in one or more memories or storage devices listed herein. The processes described with respect to the exemplary embodiments can include appropriate data structures for storing data collected and/or generated by the processes of the devices and subsystems of the exemplary embodiments in one or more databases.

All or a portion of the exemplary embodiments can be conveniently implemented using one or more general purpose processors, microprocessors, digital signal processors, micro-controllers, and the like, programmed according to the teachings of the exemplary embodiments of the present inventions, as will be appreciated by those skilled in the computer and/or software art(s). Appropriate software can be readily prepared by programmers of ordinary skill based on the teachings of the exemplary embodiments, as will be appreciated by those skilled in the software art. Further, the exemplary embodiments can be implemented on the World Wide Web. In addition, the exemplary embodiments can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware and/or software.

Stored on any one or on a combination of computer readable media, the exemplary embodiments of the present inventions can include software for controlling the components of the exemplary embodiments, for driving the components of the exemplary embodiments, for enabling the components of the exemplary embodiments to interact with a human user, and the like.

Such software can include, but is not limited to, device drivers, firmware, operating systems, development tools, applications software, and the like. Such computer readable media further can include the computer program product of an embodiment of the present inventions for performing all or a portion (if processing is distributed) of the processing performed in implementing the inventions. Computer code devices of the exemplary embodiments of the present inventions can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments of the present inventions can be distributed for better performance, reliability, cost, and the like.

As stated above, the components of the exemplary embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, trans-mission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CD-R, CD-RW, DVD, DVD-R, DVD+R, DVD-RW, DVD+RW, DVD-RAM, HD-DVD, Blu-ray Disc, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

While the present inventions have been described in connection with a number of exemplary embodiments, and implementations, the present inventions are not so limited, but rather cover various modifications, and equivalent arrangements, which fall within the purview of prospective claims.

1-25. (canceled)

26. A method, comprising:
in response to at least one socket being bound to a relayed transport address by at least one application, intercepting socket calls made by the at least one application to the bound socket, replacing each intercepted socket call with a predetermined network address translator traversal protocol message, and forwarding the network address translator traversal protocol messages to a network address translator traversal server, the relayed transport address assigned by the network address translator traversal server for data packet relay use by the at least one application behind the network address translator; and
in response to at least one network address translator traversal protocol message being sent from the network address translator traversal server to the at least one application, intercepting the sent at least one network address translator traversal protocol message, analyzing data in the intercepted at least one network address translator traversal protocol message, and forwarding the data to the at least one socket bound to the relayed transport address based on the analysis.

27. The method according to claim 26, wherein the network address translator traversal protocol comprises a session traversal utilities for network address translation protocol provided with traversal using relays around network address translation extension.

28. The method according to claim 27, wherein at least one intercepted socket call comprises a socket call connect, and wherein the replacing predetermined network address translator traversal protocol message comprises a connect request message.

29. The method according to claim 27, wherein at least one intercepted socket call comprises a socket call connect, and wherein the replacing predetermined network address translator traversal protocol message comprises a set active destination request message.

30. The method according to claim 27, wherein at least one intercepted socket call comprises a socket call send, and wherein the replacing predetermined network address translator traversal protocol message comprises a send indication message.

31. The method according to claim 27, wherein at least one intercepted socket call comprises a socket call receive, and wherein the replacing predetermined network address translator traversal protocol message comprises a data indication message.

32. The method according to claim 26, wherein the at least one socket bound to the relayed transport address comprises one of a datagram socket and a stream socket.

33. The method according to claim 26, wherein the assigned relayed transport address comprises multiple ports, each for binding to one socket.

34. An apparatus, comprising:
a first interceptor configured to intercept, in response to at least one socket being bound to a relayed transport address by at least one application behind a network address translator, socket calls made by the at least one application to the bound socket, replace each intercepted socket call with a predetermined network address translator traversal protocol message, and forward the network address translator traversal protocol messages to a network address translator traversal server, the relayed transport address assigned by the network address translator traversal server for data packet relay use by the at least one application behind the network address translator; and
a second interceptor configured to, in response to at least one network address translator traversal protocol message being sent from the network address translator traversal server to the at least one application, intercept the sent at least one network address translator traversal protocol message, analyze data in the intercepted at least one network address translator traversal protocol message, and forward the data to the at least one socket bound to the relayed transport address based on the analysis.

35. The apparatus according to claim 34, wherein the network address translator traversal protocol comprises a session traversal utilities for network address translation protocol provided with traversal using relays around network address translation extension.

36. The apparatus according to claim 35, wherein at least one intercepted socket call comprises a socket call connect, and wherein the replacing predetermined network address translator traversal protocol message comprises a connect request message.

37. The apparatus according to claim 35, wherein at least one intercepted socket call comprises a socket call connect, and wherein the replacing predetermined network address translator traversal protocol message comprises a set active destination request message.

38. The apparatus according to claim 35, wherein at least one intercepted socket call comprises a socket call send, and wherein the replacing predetermined network address translator traversal protocol message comprises a send indication message.

39. The apparatus according to claim 35, wherein at least one intercepted socket call comprises a socket call receive, and wherein the replacing predetermined network address translator traversal protocol message comprises a data indication message.

40. The apparatus according to claim 34, wherein the at least one socket bound to the relayed transport address comprises one of a datagram socket and a stream socket.

41. The apparatus according to claim 34, wherein the assigned relayed transport address comprises multiple ports, each for binding to one socket.

42. A computer program embodied on a computer readable medium, the computer program controlling a data-processing device to perform:
in response to at least one socket being bound to a relayed transport address by at least one application, intercepting socket calls made by the at least one application to the bound socket, replacing each intercepted socket call with a predetermined network address translator traversal protocol message, and forwarding the network address translator traversal protocol messages to a network address translator traversal server, the relayed transport address assigned by the network address translator traversal server for data packet relay use by the at least one application behind the network address translator; and
in response to at least one network address translator traversal protocol message being sent from the network address translator traversal server to the at least one application, intercepting the sent at least one network address translator traversal protocol message, analyzing data in the intercepted at least one network address translator traversal protocol message, and forwarding the data to the at least one socket bound to the relayed transport address based on the analysis.
